(19) United States
(12) Patent Application Publication
(10) Pub. No.: US 2024/0353281 A1
(43) Pub. Date: Oct. 24, 2024

(54) PLUMBING TEST CAP AND SYSTEM FOR RUPTURING THE SAME

(71) Applicants: Nicholas V. Valentino, Springboro, OH (US); Daniel H. Woeste, IV, Fairfield, OH (US); Michael A. Stage, Springboro, OH (US); Robert William Graham, Franklin, OH (US)

(72) Inventors: Nicholas V. Valentino, Springboro, OH (US); Daniel H. Woeste, IV, Fairfield, OH (US); Michael A. Stage, Springboro, OH (US); Robert William Graham, Franklin, OH (US)

(73) Assignee: Testcaps.com LLC, Fairfield, OH (US)

(21) Appl. No.: 18/652,864

(22) Filed: May 2, 2024

Related U.S. Application Data
(63) Continuation-in-part of application No. 17/494,867, filed on Oct. 6, 2021, now abandoned.
(63) Continuation-in-part of application No. 16/695,300, filed on Nov. 26, 2019, now Pat. No. 11,685,525.

(51) Int. Cl. G01M 3/02; B21D 28/14; B64U 101/26; F16L 55/115

(52) U.S. Cl. CPC G01M 3/022; B21D 28/14; B64U 2101/26; B64U 2201/20; F16L 55/115

(57) ABSTRACT

A system, method and apparatus for rupturing a test seal part from a vent positioned on a roof of a structure and without requiring a person on site to accomplish the same includes a test seal part, wherein the seal part removably sealably connects to the plumbing vent pipe, and a remote controlled apparatus and/or remote controller directly or indirectly ruptures the test seal part.

This application is a continuation in part of U.S. Ser. No. 17/494,867 filed Oct. 6, 2021 which is a continuation of U.S. Ser. No. 16/695,300 filed Nov. 26, 2019, issued as U.S. Pat. No. 11,685,525 issued on Jun. 27, 2023 and claims the benefit thereof.

### FIELD OF THE INVENTION

The present invention relates generally to plumbing systems. In particular, the present invention relates to a novel test cap and system using the test cap on a plumbing vent pipe during testing of the system and post testing rupturing the same. The system may be conducted by an operator remote to the vent pipe site.

### BACKGROUND OF THE INVENTION

Plumbing codes require that plumbing systems be vented through a plumbing vent pipe extending above the building roof. Additionally, codes require a plumbing system to be pressure tested during rough-in inspections, and that a final manometer plumbing test be performed after the plumbing fixtures have been set in place.

Test caps are used for sealing the plumbing system vent pipe during pressure testing. Once testing is completed, the test cap must be removed so that the plumbing vent pipe may provide adequate venting of the installed plumbing system.

Some statutes require that all test caps on plumbing vent pipes be visible from ground level. Such laws were enacted to allow an inspector to see if the test cap was in place and to see if the test cap is removed after final plumbing inspections. Failure to remove plumbing vent pipe test caps results in inadequate or no ventilation of the plumbing system and the air has to escape out one of the other plumbing fixtures.

Many systems exist for capping plumbing roof vents for testing purposes. Such systems include the use of glue on caps, plastic wafers, rubber caps, screw-in plugs, or temporary caps.

All of these prior systems require removal post inspection. Additionally, some of these can fail prior to testing if not secured properly. Some are positioned in places where the inspector can hardly tell from ground level whether the test cap is in place or has been removed and one must climb up onto the building roof to determine this.

In this situation as well as post inspection, getting on a roof with a steep pitch is very undesirable particularly in inclement weather. Currently, after testing is completed, the test cap is removed by climbing onto the roof and mechanically removing the cap by means of a screwdriver or cutting the test cap off.

Additional construction problems exist in installing roof flashing and boot around plumbing vent pipes without breaking an existing cap. A typical plastic test cap system includes gluing a plastic test plug or vent cap over the plumbing vent pipe. Again, in order to remove the test cap, usually the plumber must climb onto the building roof and saw it off. In some applications, the plumber enters the attic and removes the cap by cutting off the part and then putting a new connection in and pushing it through the exiting roof hole which of course leads to leak issues around the dotted boot on the roof. Often times this method requires a plumber to climb a ladder into a restricted attic space resulting in damaged attic insulation and additional time expended in removal of the test cap and clean-up of insulation. Often times, this is done without complying with OSHA requirements, specifically, using a rope and harness to secure their safety. Additionally, there are possibilities that the plumber may forget to clean-out plug, allowing sewer gases to escape into the house. Other means for removing the test exit, but all typically require the plumber to be on site post the structure completion which is months after the plumber's job is essentially completed.

The present invention overcome the deficiencies in the art related to test caps for use in capping a plumbing system vent pipe during the pressure testing of the plumbing system. The present invention allows for easy opening of the vent pipe of the equipment after a completed inspection without the need for anyone to climb onto the building roof.

### SUMMARY OF THE INVENTION

It is an object to improve the system, method and apparatus of pressure testing of the plumbing system.

A further object is to provide a system and apparatus for relieving pressure from the plumbing system post inspection.

Still another object is to provide a control system and apparatus for pressure testing of the plumbing system.

Accordingly, the present invention provides a system and apparatus for rupturing a test seal part on a vent positioned on a roof of a structure and being rupturable with or without a person required on site to accomplish the same. The test seal part includes a rupturable surface.

The system and apparatus includes test seal part removably sealably connected to a plumbing vent pipe. A remote controlled apparatus is provided for rupturing the test seal part. In one embodiment, the remote controlled apparatus includes an unmanned aerial vehicle (UAV) which is a remote controlled aircraft (e.g. flown by a pilot at a ground control station) or can fly autonomously based on pre-programmed flight plan or more complex dynamic automation systems, wherein the UAV is equipped with a device for rupturing a test seal part on the plumbing vent pipe post inspection.

In a preferred version, it is envisioned the seal part includes a rupturable surface and a tool for rupturing the rupturable surface of test seal cap.

Still another aspect of the invention is to provide a locating device, such as an identification chip, such as an NFC chip, in the seal part and providing the UAV with a complementary locating device, such as an NFC locating device, for aiding in removal of the test seal part.

Additionally, the there can be provided transducer which permits transmission of signal corresponding to pressure and is operably connected to the battery and wherein the sensed pressure can be transmitted.

To remove the seal part, the remote controlled apparatus is initiated whereby a rupturing tool connect to the seal part in a manner to rupture a reupturable surface of the part thereby breaking a seal with the vent pipe to permit air to pass through the vent pipe.

### BRIEF DESCRIPTION OF THE DRAWINGS

FIG. 1 is a schematic of a typical vent pipe extending from a roof of a building.

FIG. 2A depicts an embodiment of the invention.

FIG. 2B depicts a portion of the embodiment of the embodiment with a partial cutaway of FIG. 2A through lines A-A.

FIG. 2C depicts a portion of the embodiment of the embodiment with a partial cutaway of FIG. 2A through lines B-B.

FIG. 3 depicts the rupturing device of the invention in a compressed and loaded state.

FIG. 4 depicts the rupturing device of the invention in a released extended state.

### DETAILED DESCRIPTION OF PREFERRED EMBODIMENTS

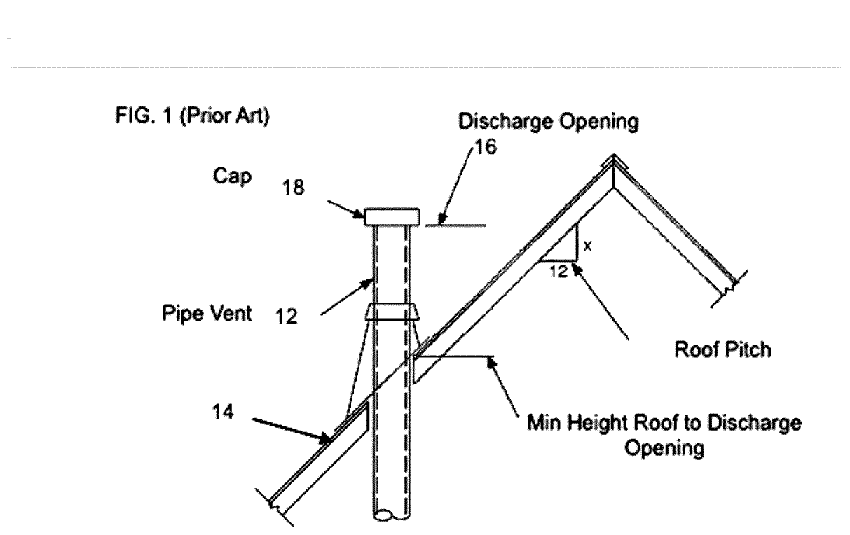

Referring now to the drawings, a system for rupturing a test seal part on a vent positioned on a roof of a structure and being rupturable by a person on site or remotely located, to accomplish the same is generally referred to by the numeral 10. As noted in FIG. 1 Prior Art, there is provided a vent pipe 12 which extends through a roof 14 which, by conventional code, extends a minimum height from the roof 14 to a discharge opening 16. The vent pipe 12 includes a test cap 18 which is conventionally sealed in a fixed way (typically epoxy) until a standardized pressure test is conducted. Once the pressure test is conducted, the test cap 18 is removed as previously described above by cutting or otherwise knocking it off the pipe.

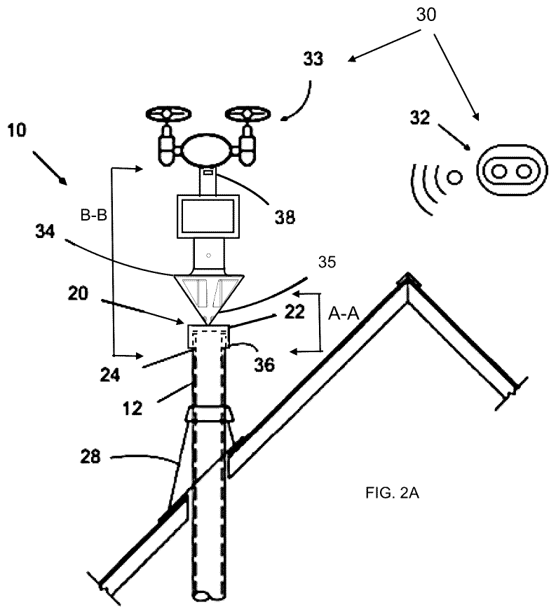

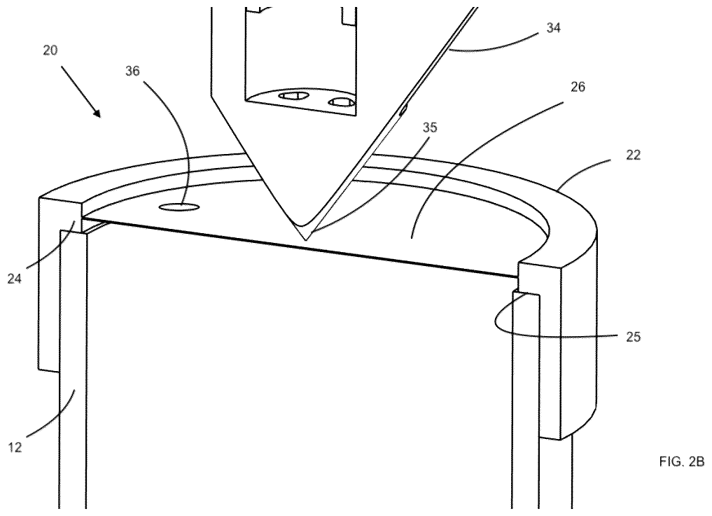

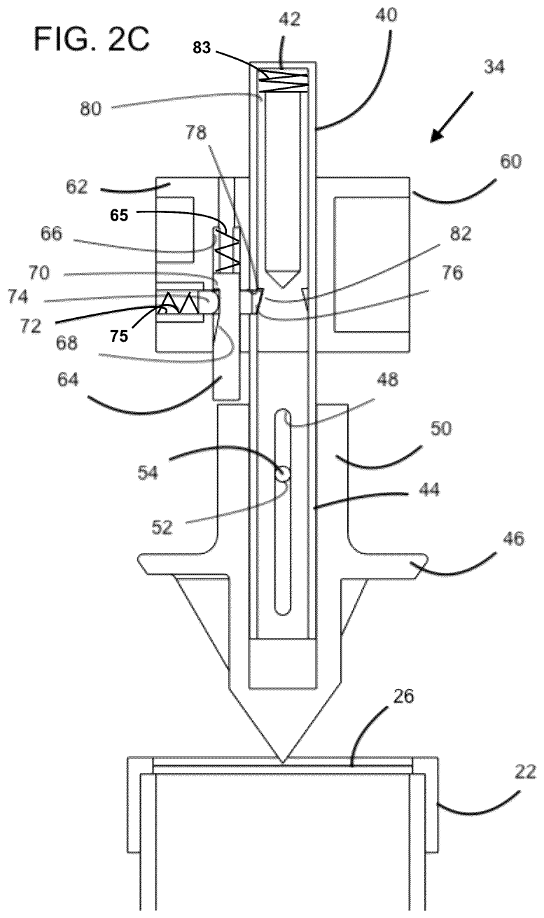

As can be seen in the embodiment represented in FIG. 2A and FIG. 2B, the current system 10 has a test seal part 20, which can include a test cap 22 having a sealable connectable neck 24 which has a sealed surface 25 to prevent fluid flow thereby, and retains the test part 20 in place on the vent pipe 12, withstanding at least up to a predetermined pressure, e.g., 5 lbs and/or vacuum at such pressure.

As depicted in FIG. 2B, the test cap 22 can include a rupturable surface 26, such as a foil made of a suitable strength material and affixed to the test cap 22, for example, by way of an in-mold production technique. The ruptuable surface (foil) 26 can be robotically or manually inserted into a mold and plastic can be injected about the perimeter of the foil 26 to form a seal tight connection. The foil 26 can be punctured by a sharp or pointed surface 35 of a rupurting device 34. The test cap 22 is configured in a manner to not interfere with the installation of a boot 28.

A remote controlled apparatus 30 in conjunction with a remote controller 32 is provided for rupturing the test seal part 20. In this embodiment, the remote controlled apparatus 30 includes an unmanned aerial vehicle (UAV) 33 which is remote controlled aircraft (e.g. flown by a pilot at a ground control station) or can fly autonomously based on pre-programmed flight plan or more complex dynamic automation systems by remote controller 32 such as a computer based, wherein the UAV 33 is equipped with the rupturing device 34 for piercing the test seal part 20 connected the plumbing vent pipe 12 post inspection.

In a preferred version, it is envisioned the test seal part 20 includes rupturable surface 26, such foil formed on the test cap 22, and which the rupturing device 34 punctures for enabling pressure release after completing testing. The rupturing device 34 can include piercing surface 47, for example a cone shaped surface, or other functional configured surface for rupturing the rupturable surface 26.

As seen in FIG. 2C, there is provided sectional view of the rupturing device 34 for use with the unmanned aerial vehicle 33. The rupturing device 34 includes a tubular housing 40 having first end 42 for connection to the unmanned aerial vehicle 33 and a second end 44 slidably connected to a rupturing head 46 with piercing surface 47. In this regard, the second end 33 includes a longitudinal slit 48 and the rupturing head 46 has a neck 50 which is hollow to receive the second end 44 and has coaxial openings 52 disposed in the neck 50 wherein a pin 54 which extends through the coaxial openings 52 and the slit 48 to retain the rupturing head 46 in sliding connection with the second end 44. Longitudinal travel is limited by the connection between the second end 44 and the neck 50.

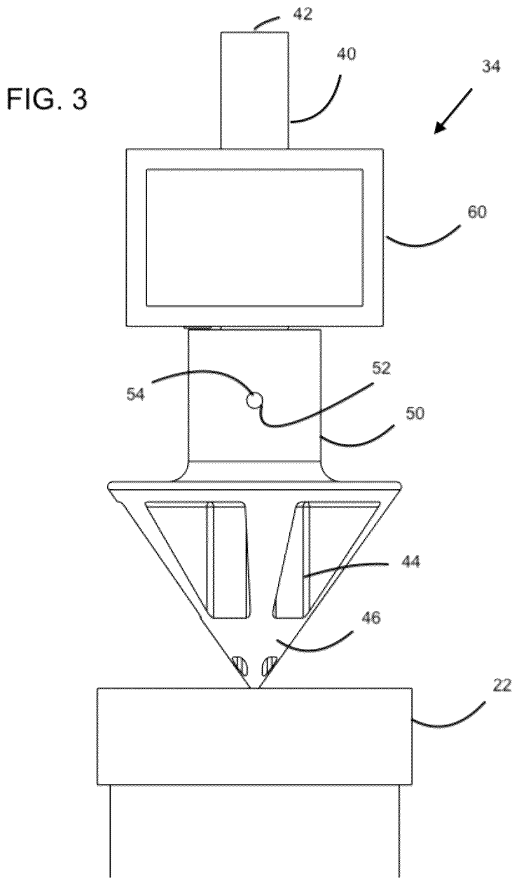

Upwardly disposed adjacent the first end 42 and connected about the tubular housing 40 is a trigger mechanism 60. As can be understood in viewing FIGS. 20, 3 and 4, the trigger mechanism 60 includes a mechanism housing 62 which is fixed on tubular housing 40. The trigger mechanism 60 includes a release pin 64 which is slidably received in a longitudinal slot 66 within the mechanism housing 60. The pin 64 has a sloped recess surface 68 terminating in a stop surface 70. Transversely intersecting longitudinal slot 66 is a radial slot 72 which slidably receives a retention pin 74 having an inwardly disposed sloped end 76. A spring 75 is disposed in radial slot 72 to bias against retention pin 74 thereby pushing the same radially inward. Coaxially aligned with radial slot 72 is an open surface 78 for receiving the inwardly disposed sloped end 76 in and out therethrough.

A slug 80, made of metal for example, is slidably disposed in housing 40 adjacent the first end 42. A spring 83 is disposed above the slug 80 biasing the plug 80 downward or toward the rupturing head 46. The slug 80 has a complementary formed sloped peripheral surface area 82 to be mated with inwardly sloped end 76 enabling retention of the slug 80. As seen in the FIG. 2C, the rupturing device 34 is in a vertical position or normal to the rupturable surface 26, and when the slug 80 is pushed into a “loaded position” as seen in FIG. 2C, a spring 65 is disposed above the release pin 64 biases against the release pin 64 to drop to stop point causing the retention pin 74 to slide inwardly and seat against the sloped peripheral surface area 82 holding the same in position.

As the rupturing head 46 contacts the rupturable surface 26, the tubular housing 40 travels downward into the rupturing head 46 and neck 50 and contacts the release pin 64 and in turn causes the release pin 64 to travel upward. When reaching a travel limit, the retention pin 74 will be moved radially outward sufficiently to release the slug 80. The slug 80 has sufficient weight such that when released it will strike the rupturing head 46 with such force causing the rupture of the rupturable surface 26. Then, the unmanned vehicle 33 can lift off with the rupturing device 34 in tow.

Still another aspect of the invention is to provide a locating device 36, such as an identification chip, such as an NFC chip, in the test seal part 20 and providing the UAV 33 with a complementary locating device 38, such as an NFC locating device, for aiding in removal of the test seal part 20.

Additionally, it is envisioned there can be provided transducer in the test seal part which permits transmission of signal indicative of a pressure within the pipe and this can be operably connected to the test seal part 20.

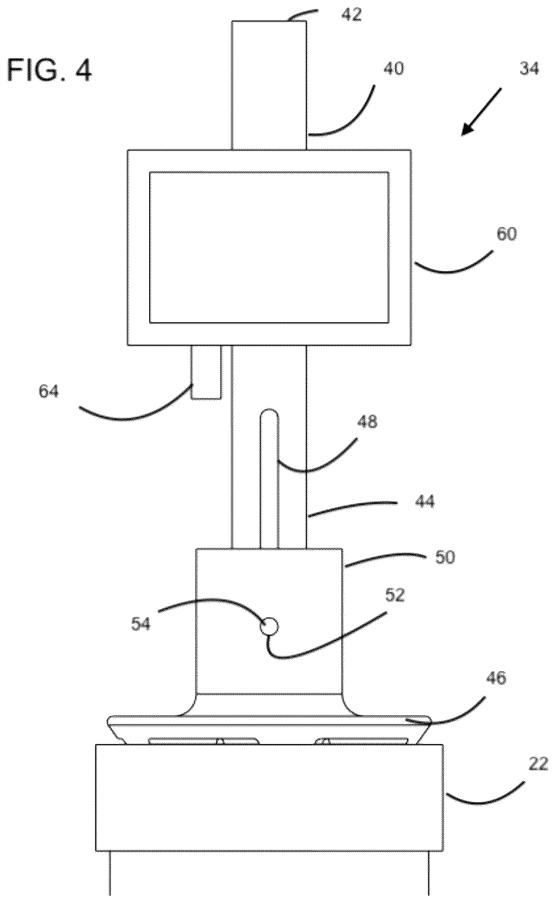

To remove the seal part, the UAV 33 and/or remote control 32 are initiated. Either directly or indirectly the UAV 33 and/or remote control 32 connects to the seal part 20 and lands on the test cap 22 and through the use of simple gravity, causing the rupturable device 34 to be moved breaking a seal with the vent pipe 14 to permit air to pass therethrough as depicted in FIG. 4.

While the present invention has been illustrated by a description of one or more embodiments and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

1. A test seal part for a vent positioned on a roof of a structure, wherein the test seal part includes:
a cap portion configured to sealably connect on a part of a vent pipe; and
a rupturable surface connected to said cap portion.

2. The test seal part of claim 1, wherein said cap portion includes a cylindrical member and said rupturable surface spans an area between said cylindrical member.

3. The test seal part of claim 1, wherein said rupturable surface includes a rupturable member which is integrally connected to said cap portion.

4. An apparatus for removing a test seal part from a vent positioned on a roof of a structure, wherein the system includes:
a cap portion configured to sealably connect on a part of a vent pipe; and
a rupturable surface connected to said cap portion;
a rupturing device disposed on said rupturable surface in a manner to rupture said rupturable surface upon force being applied thereto.

5. The apparatus for removing a test seal part from a vent positioned on a roof of a structure of claim 4, which further includes remote controlled apparatus having an unmanned aerial vehicle operably connected to said rupturing device, and a remote controller for controlling said unmanned aerial vehicle to cause positioning said rupturing device over said rupturable surface and rupturing thereof.

6. The apparatus for removing a test seal part from a vent positioned on a roof of a structure of claim 5, which includes a locating device on said test seal part and providing said remote controlled apparatus with a complementary locating device for aiding in location and rupturing of said rupturable surface.

7. A rupturing device for use in rupturing a rupturable surface, which includes:
a rupturing head operably connected to a first end configured with a surface for connection to an unmanned vehicle and having a piercing surface.

8. The rupturing device of claim 7, including an actuatable slug which when released impacts said rupturing head.
